(19) United States
(12) Patent Application Publication
(10) Pub. No.: US 2026/0330562 A1
(43) Pub. Date: Oct. 22, 2026

(54) DYNAMIC USER INTERFACE VIEW GENERATION

(71) Applicant: State Farm Mutual Automobile Insurance Company, Bloomington, IL (US)

(72) Inventors: Derick Owens, Madison, WI (US); Austin Stockecke, Philadelphia, PA (US); Paul Bloemer, Bloomington, IL (US)

(21) Appl. No.: 19/186,282

(22) Filed: Apr. 22, 2025

(51) Int. Cl. G06Q 40/08

(52) U.S. Cl. CPC G06Q 40/08

(57) ABSTRACT

A computing system determines operation data associated with an operation performed via a policy management system. The operation data indicates an operation type associated with the operation and a location identifier indicating a policyholder location associated with the operation. The computing system determines a mode that corresponds with the location identifier. The computing system dynamically generates a user interface view that presents information associated with the operation in a format determined based on the mode and the operation type.

### TECHNICAL FIELD

The present disclosure relates to a policy management system, and more particularly, to dynamically generating user interface views for a policy management system based on one or more parameters.

### BACKGROUND

Individuals, companies, and other entities often hold insurance policies with insurance companies. For example, insurance policies may include automobile insurance policies, home insurance policies, and other types of insurance policies. Insurance companies may use computer-implemented policy management systems to store information about insurance policies, create new insurance policies, change existing insurance policies, and/or otherwise manage insurance policies.

Users may interact with a computer-implemented policy management system via a user interface (UI), such as a graphical user interface (GUI), via a web browser, executable application, or other software or computer-executable element. For instance, a user may use a laptop computer, mobile device, or other computing system to access and use the UI of the policy management system. The user may perform operations, via the UI of the policy management system, to view information about existing insurance policies, change information about existing insurance policies, create new insurance policies, and/or otherwise manage insurance policies.

However, it may be difficult and/or time-intensive for a developer of the policy management system to develop, test, and/or maintain code that causes the policy management system to present distinct UI views corresponding to numerous possible scenarios that may occur during use of the policy management system. The UI may display different UI views that present different types of information, or the same or similar types of information in different layouts and/or detail levels, depending on which operation is being performed via the policy management system, the location of the corresponding policyholder, a user type of the user interacting with the policy management system, and/or other variables. Conventionally, each UI view may be statically-coded such that the policy management system uses a distinct code set to generate and display each different UI view. However, it may be difficult, time-intensive, and/or resource-intensive to generate, test, and maintain distinct sets of code for displaying distinct UI views that are each respectively associated with a different combination of variables.

As an example, if there are seven types of operations that may be performed via the policy management system, there may be seven corresponding UI views that could be displayed via the policy management system. In many conventional systems, seven different code sets, one for each of the seven types of operations and corresponding static UI views, may be developed and tested. Because the same or similar types of information may be displayed in each of the seven static UI views in association with the seven different types of operations, there may be significant amounts of repeated code across the corresponding seven different code sets. Storing and/or using seven different code sets for seven corresponding static UI views may accordingly consume memory resources, computing cycles, and/or other computing resources. It may also be difficult, time-intensive, and/or resource-intensive to perform software testing with respect to each of the seven different code sets, as computing resources may be devoted to generating and executing tests in association with each of the seven different code sets. Similarly, if updates are to be made to elements that are repeated across multiple code sets, it may be difficult, time-intensive, and/or resource-intensive to change each of the code sets separately, and there may be a risk that one or more of the code sets are not updated in the same way as other code sets.

Moreover, if there are seven different types of operations, but information to be displayed in the UI with respect to those seven types of operations varies further depending on whether a corresponding policyholder is located in a first state or a second state, there may be two possible UI views associated with each of the seven operation types and fourteen possible UI views in total. It may accordingly be more difficult, time-intensive, and/or resource-intensive to create, test, and maintain distinct code sets for fourteen different possible UI views, relative to seven different possible UI views.

Similarly, there may be additional possible UI views if the information to be displayed for individual combinations of operation types and policyholder locations is based in part on a user type of the user interacting with the policy management system. Accordingly, it may be difficult, time-intensive, and/or resource-intensive to create, test, and maintain numerous distinct code sets that correspond to numerous distinct UI views associated with numerous possible combinations of operation types, policyholder locations, and user types.

The example systems and methods described herein may be directed toward mitigating or overcoming one or more of the deficiencies described above.

### SUMMARY

Described herein are systems and methods for dynamically generating user interface views, presented via a user interface of a computer-implemented policy management system, in association with corresponding operations performed via the policy management system. The policy management system may allow users to perform operations associated with management of policies, for instance to create new policies and to edit existing policies. A user interface view generator may dynamically generate a user interface view for an operation based at least in part on a mode that corresponds to a location of a policyholder associated with the operation. Information for the same type of operation may be presented differently in the user interface according to different modes if locations of respective policyholders correspond to the different modes. Particular types of information may also be displayed or hidden depending on additional factors such as the type of operation and/or the type of user using the policy management system.

In some aspects described herein, a computer-implemented method includes determining, by a computing system including a processor, operation data associated with an operation performed via a policy management system. The operation data indicates an operation type associated with the operation and a location identifier indicating a policyholder location associated with the operation. The computer-implemented method also includes determining, by the computing system, a mode that corresponds with the location identifier. The computer-implemented method also includes dynamically generating, by the computing system, a user interface view that presents information associated with the operation in a format determined based on the mode and the operation type.

In some aspects described herein, a computing system includes one or more processors and memory storing computer-executable instructions. The computer-executable instructions, when executed by the one or more processors, cause the one or more processors to execute a policy management system. The policy management system is configured to perform operations to manage policies based on corresponding policy data. The computer-executable instructions also cause the one or more processors to determine operation data associated with an operation performed via the policy management system. The operation data indicates an operation type associated with the operation and a location identifier indicating a policyholder location associated with the operation. The computer-executable instructions also cause the one or more processors to determine a mode that corresponds with the location identifier. The computer-executable instructions also cause the one or more processors to dynamically generate a user interface view that presents information associated with the operation in a format determined based on the mode and the operation type.

In some aspects described herein, one or more non-transitory computer-readable media store computer-executable instructions associated with a policy management system. The computer-executable instructions, when executed by one or more processors of a computing system, cause the policy management system to determine operation data associated with an operation performed via the policy management system. The operation data indicates an operation type associated with the operation and a location identifier indicating a policyholder location associated with the operation. The computer-executable instructions also cause the policy management system to determine a mode that corresponds with the location identifier. The computer-executable instructions also cause the policy management system to dynamically generate a user interface view that presents information associated with the operation in a format determined based on the mode and the operation type.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example computing environment in which a policy management system may be used to manage policies based on corresponding policy data.

FIG. 2 shows an example of a first UI view that may be displayed in the UI of the policy management system for an operation based on a first mode.

FIG. 3 shows an example of a second UI view that may be displayed in the UI of the policy management system for an operation based on a second mode.

FIG. 4 shows a flowchart illustrating an example method for dynamically generating a UI view for a corresponding operation performed via the policy management system.

FIG. 5 shows a flowchart illustrating an example method 500 for modifying the policy management system 102 to use the UI view generator 120 to dynamically generate UI views 110 associated with operations performed via the policy management system 102.

FIG. 6 shows an example system architecture for a computing system that may execute one or more elements of the policy management system, the UI view generator, and/or other elements described herein.

### DETAILED DESCRIPTION

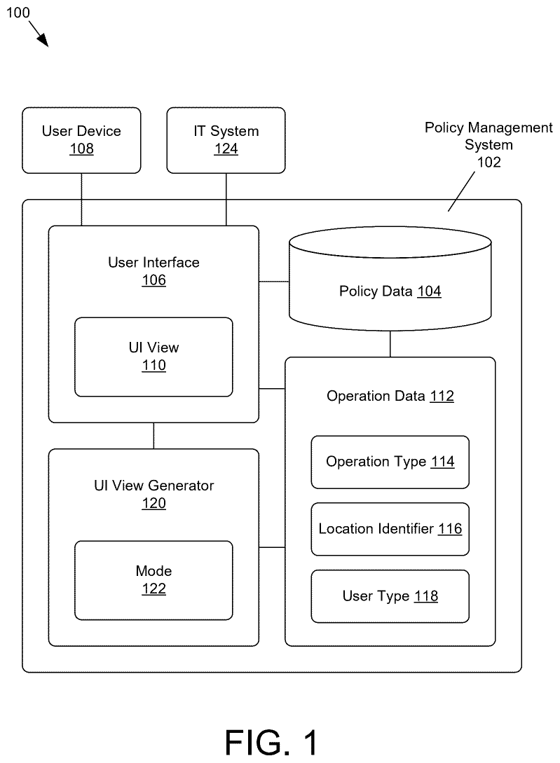

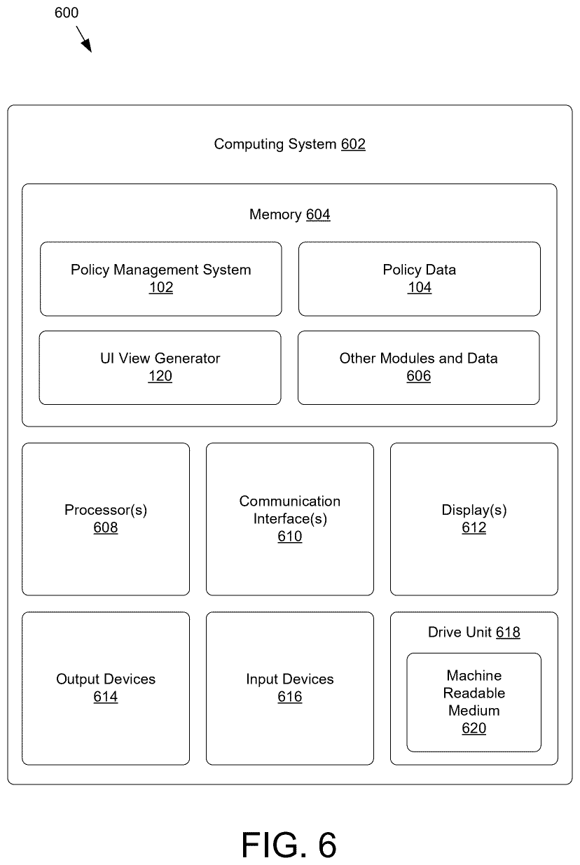

FIG. 1 shows an example computing environment 100 in which a policy management system 102 may be used to manage policies based on corresponding policy data 104. The policy management system 102 may be a software application, web-based platform, or other computer-implemented system. An example system architecture for a computing system that may execute the policy management system 102, and/or other elements described herein, is discussed further below with reference to FIG. 6.

Policies managed via the policy management system 102 may be insurance policies provided by an insurance company, and may be associated with corresponding policyholders. Such insurance policies may be vehicle insurance policies, home insurance policies, property insurance policies, life insurance policies, and/or other types of insurance policies. In some examples, policies managed via the policy management system 102 may be other types of policies, such as organizational policies, compliance policies, user policies, and/or other types of policies. Policies may be associated with corresponding policyholders. As an example, a policyholder for an automobile insurance policy may be a driver or owner of a vehicle covered by the automobile insurance policy. As another example, a policyholder for a business's organizational policy may be the business, or a particular group or office location associated with the business.

The policy data 104 may include digital records, user input, and/or other data that indicates information about corresponding policies, such as new and/or existing policies. The policy data 104 may include, or be associated with, digital contracts, digital images, electronic documents, database records, and/or other types of data.

For example, policy data 104 associated with a vehicle insurance policy may include electronic documents, database records, and/or other types of data that indicate one or more types of information about the vehicle insurance policy. Such policy information may express attributes including an identifier of the policyholder associated with the vehicle insurance policy, a residential address and/or other contact information of the policyholder, a policy number, a term and/or term length, an agreement number, an identifier of an insurance agent associated with the vehicle insurance policy, an identifier of a vehicle covered by the vehicle insurance policy, vehicle use information associated with the vehicle, driver exclusions, billing methods, billing account information, historical information associated with the vehicle insurance policy, and/or other types of information. Policy data 104 for other types of insurance policies may indicate similar types of information relevant to the other types of insurance policies.

The policy data 104 may be stored in one or more databases or other data repositories that are part of, or are accessible by, the policy management system 102. The policy management system 102 may access and/or interact with the policy data 104 to perform operations associated with management of corresponding policies. For example, the policy management system 102 may access and/or edit policy data 104 associated with policies to perform corresponding operations, such as operations to renew policies, operations to create new policies, operations to adjust insurance coverage provided by policies, operations to terminate policies, and/or other types of actions, transactions, or other operations associated with new and/or existing policies.

The policy management system 102 may have a user interface (UI) 106 that allows users to perform operations, via the policy management system 102, to view, edit, and/or otherwise manage policy data 104 associated with policies. Users of the policy management system 102 may be insurance agents, claims adjustors, insured parties, underwriters, developers of the policy management system 102, testers of the policy management system 102, information technology (IT) support personnel, and/or other types of users. The users may, for example, be associated with an insurance company that provides insurance policies to policyholders.

Users may use user devices 108, such as the user device 108 shown in FIG. 1, to access the UI 106 of the policy management system 102 and to perform operations via the policy management system 102. For example, the user device 108 may be a computer, mobile device, or other type of computing system that allows a user to access and interact with the UI 106 of the policy management system 102 via a website, a web application, a web portal, a local application executing on the user device 108, or another type of software or computer-executable element.

A user may, via a user device 108, provide user input and/or other information or instructions associated with an operation to be performed via the policy management system 102. As described further below, the UI 106 of the policy management system 102 may display a UI view 110 that presents information to a user and/or accepts user input from the user, for instance in association with an operation.

Operation data 112 tracked or maintained by the policy management system 102 may indicate one or more parameters of an operation that is being performed or that is to be to performed, via the policy management system 102. The operation data 112 may be based on user input associated with the operation, policy data 104 associated with the operation, and/or other information associated with the operation that is generated, maintained, and/or accessible by the policy management system 102. The operation data 112 associated with an operation may indicate corresponding values of parameters such as an operation type 114, a location identifier 116, and/or a user type 118.

The operation type 114 parameter, in operation data 112 associated with an operation, may indicate a type of the operation. As discussed above, the policy management system 102 may be configured to allow users to perform various types of operations in association with policies. As a non-limiting example, the policy management system 102 may allow users to perform submission operations associated with new policies, issuance operations associated with new policies, cancellation operations associated with existing policies, reinstatement operations associated with lapsed or canceled policies, renewal operations associated with renewals of existing policies for new terms, rewrite operations associated with replacements of policies, new account rewrite operations associated with replacements of policies in association with new accounts, and/or other types of operations. Accordingly, a value of the operation type 114 parameter in operation data 112 may indicate which particular type of operation a user is attempting to perform via the policy management system 102.

The location identifier 116 parameter, in operation data 112 associated with an operation, may indicate a location of a policyholder associated with the operation. As a non-limiting example, if the operation is associated with a policy for a policyholder located in the state of Illinois, a value of the location identifier 116 in corresponding operation data 112 may indicate that the associated policyholder is in Illinois. However, if an operation is associated with a policy for a policyholder located in the state of Nevada, a value of the location identifier 116 in corresponding operation data 112 may indicate that the associated policyholder is in Nevada. In examples in which an operation is associated with creation or alteration of a policy in association with a new or prospective policyholder, the location identifier 116 may indicate the location of the new or prospective policyholder.

The user type 118 parameter, in operation data 112 associated with an operation, may indicate a type of the user of the policy management system 102 that is associated with the operation. The user type 118 may be determined based on a login account of the user, based on a user profile associated with the user that is tracked by the policy management system 102, based on a human resources profile of the user, and/or based on other data. As discussed above, different types of users may use the policy management system 102, such as insurance agents, claims adjustors, insured parties, underwriters, developers of the policy management system 102, testers of the policy management system 102, IT support personnel, and/or other types of users. Accordingly, when a particular user is attempting to perform an operation via the policy management system 102, a value of the user type 118 parameter in corresponding operation data 112 may indicate that the particular user is an insurance agent, an underwriter, an IT support user, or another type of user.

As discussed above, the UI 106 may display a UI view 110 in association with a corresponding operation. As an example, if a user is performing an operation associated with creation of a new policy, a corresponding UI view 110 displayed the UI 106 may present details of a quote for the new policy. Similarly, if a user is performing an operation associated with a renewal of an existing policy, a corresponding UI view 110 displayed the UI 106 may present details of a quote for the policy renewal.

However, although in this example the new policy operation and the policy renewal operation may both lead to presentation of corresponding quote details within the UI 106, different UI views 110 associated with the new policy operation and with the policy renewal operation may present the same or similar types of quote details using different detail levels, different layouts, and/or using other different presentation formats or attributes. As a non-limiting example, quote details presented in a UI view 110 in association with the policy renewal operation may include details about a renewal term, but quote details presented in a UI view 110 in association with the new policy operation may omit details about a renewal term. However, other types of quote details, such as premium amounts, coverage details, and/or other information, may be presented in both of the different UI views 110 associated with the policy operation and with the policy renewal operation.

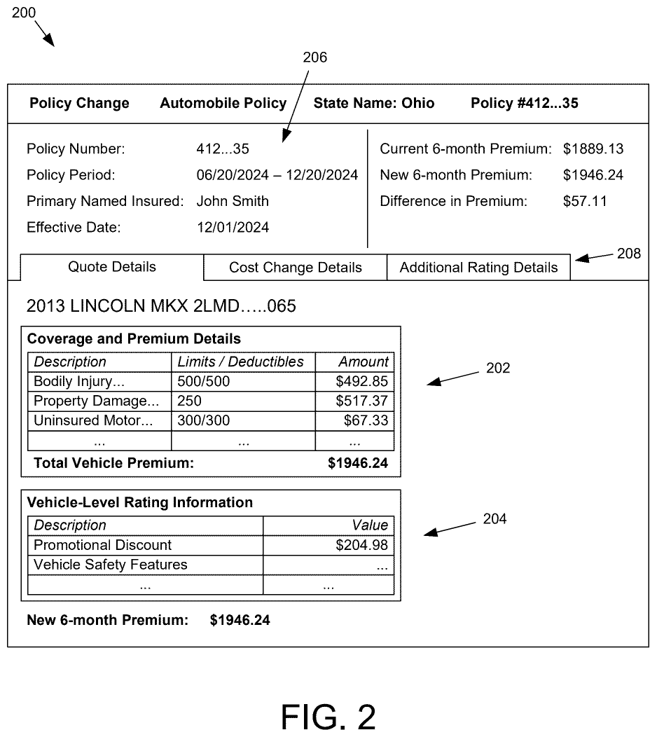

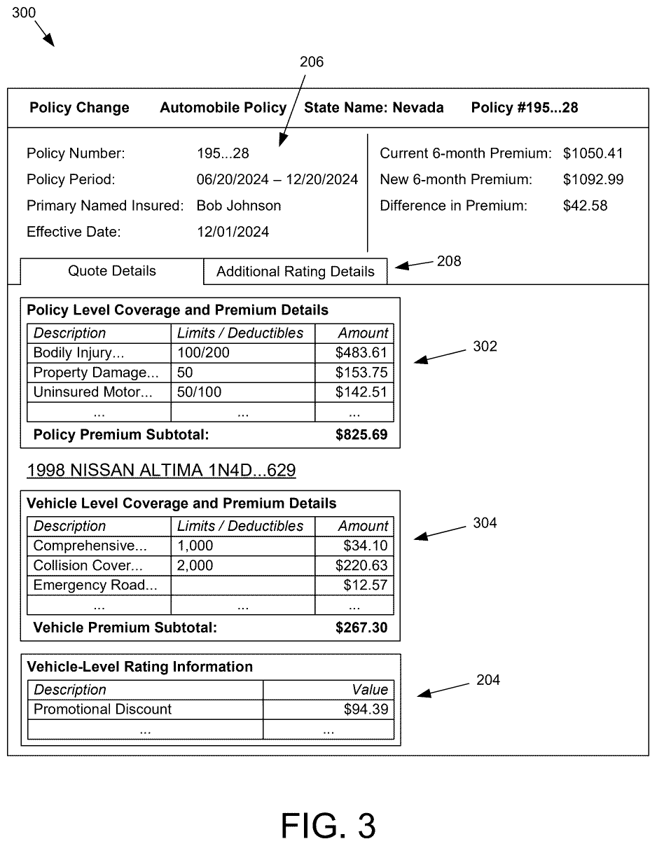

Different UI views 110 may also present quote details, in association with the same type of operation and/or different types of operations, differently depending on the location of a policyholder associated with an operation. For example, different states may have different laws, requirements, or guidelines that impact how quote details are to be displayed in the UI 106. Many states may allow quote details for an automobile insurance policy to be displayed such that summarized details about the overall automobile insurance policy are presented in the UI 106, for example as discussed further below with respect to FIG. 2. However, other states such as Nevada and Montana may require that quote details for an automobile insurance policy be displayed such that details about the overall insurance policy are divided into sections for policy-level details and vehicle-level details, for example as discussed further below with respect to FIG. 3. Accordingly, the UI 106 may display different UI views 110 that present quote details differently, for the same and/or different operation types, depending on locations of the corresponding policyholders.

Different UI views 110 may also present quote details, in association with the same type of operation and/or different types of operations, differently depending on a type of the user associated with an operation. For example, an operation that modifies a policy during a term may lead to policy premiums and/or other values being pro-rated for the remainder of the term due to the modification. Such proration details may be displayed via the UI 106 to some types of users in association with a corresponding operation type, such as insurance underwriters or IT personnel. However, those proration details may be hidden from insurance agents and/or other types of users in association with the same operation type, such that the UI 106 does not present the proration details to those types of users in association with that operation type.

The specific types of information, and/or layouts and detail levels, to be presented via UI views 110 associated with corresponding operations may vary depending on operation types, policyholder locations, user types, and/or other parameters. Accordingly, the policy management system 102 may have, or use, a UI view generator 120 that is configured to dynamically generate a UI view 110 displayed via the UI 106 in association with a corresponding operation. In some examples, the UI view generator 120 may be an element of the policy management system 102. In other examples, the UI view generator 120 may be a plug-in or add-on to the policy management system 102, or an element that executes separately from the policy management system 102 that may be called or accessed by the policy management system 102 in association with an operation.

The UI view generator 120 may use values of one or more parameters in the operation data 112 corresponding to an operation, such as the operation type 114, the location identifier 116, and/or the user type 118, to dynamically determine layouts, presentation formats and/or types of data elements to present in the associated UI view 110. In some examples, the UI view generator 120 may be based on a model view controller (MVC) design pattern, such that a controller is configured to dynamically determine the UI view 110 to be displayed in the UI 106 based on a data model.

The UI view generator 120 may be configured to use the location identifier 116, of operation data 112 associated with an operation, to determine a mode 122 associated with the operation. Different modes 122 may be associated with different presentation formats that present different types of information, and/or present information using different layouts or details levels, in the UI 106. Accordingly, the UI view generator 120 may dynamically generate a UI view 110 associated with an operation based at least in part on the presentation format that corresponds to the mode 122 associated with the operation.

The UI view generator 120 may be configured to use, and select between, multiple modes 122. As an example, the modes 122 may include a default mode and a specialized mode. As another example, the modes 122 may include multiple modes with distinct identifiers, such as mode 1, mode 2, mode 3, and/or other modes. The UI view generator 120 may have mapping data, rules, and/or other elements that identify policyholder locations associated with each of the modes 122. Accordingly, the UI view generator 120 may use the location identifier 116, indicated by operation data 112 associated with an operation, to identify which of the modes 122 is associated with the operation. The UI view generator 120 may also dynamically generate a UI view 110 associated with the operation based at least in part on a presentation format defined by the mode 122 associated with the operation.

For example, different states may require that quote details be presented differently in the UI 106. As a non-limiting example, as discussed above, most states may allow the UI 106 to display summarized details in association with a quote, while other states such as Nevada and Montana may require that distinct policy-level details and/or vehicle-level details be displayed in association with a quote. Accordingly, the UI view generator 120 may be configured to associate most states with a “default” mode 122 that causes a generated UI view 110 to present quote information using summarized details. However, the UI view generator 120 may be configured to associate other states, such as Nevada and Montana, with a “special” mode 122 that causes a generated UI view 110 to present quote information using distinct policy-level details and/or vehicle-level details. As another example, if a first set of states requires that quote details be presented in a first presentation format, a second set of states requires that quote details be presented in a second presentation format, and a third set of states requires that quote details be presented in a third presentation format, the UI view generator 120 may be configured to associate the first set of states with a first mode 122, the second set of states with a second mode 122, and the third set of states with a third mode 122.

In this example, the UI view generator 120 may use the location identifier 116 associated with an operation to determine which mode 122 is associated with the operation, and dynamically generate the UI view 110 for the operation based on that mode 122. For instance, if the location identifier 116 indicates that the policyholder associated with the operation is located in a state that is associated with a default mode 122, and the default mode 122 is configured to present quote information using summarized details, the UI view generator 120 may generate a UI view 110 that presents quote information using summarized details. However, if the location identifier 116 instead indicates that the policyholder associated with the operation is located in a state that is associated with a special mode 122, and the special mode 122 is configured to present quote information using distinct policy-level details and vehicle-level details, the UI view generator 120 may generate a different UI view 110 that presents quote information using distinct sections for policy-level details and vehicle-level details.

In addition to the mode 122 determined based on the location identifier 116 associated with an operation, the UI view generator 120 may also dynamically generate the corresponding UI view 110 based on the operation type 114 and/or the user type 118 associated with the operation. Although the mode 122 may indicate particular types of information, and/or particular layouts or detail levels, that are to be displayed within the UI view 110, some particular data fields or other types of information may be displayed or hidden within the UI view 110 depending on the operation type 114 and/or the user type 118.

As a non-limiting example, the mode 122 may indicate whether the UI view 110 is to display quote information by presenting summarized details, or by presenting more granular policy-level details and/or vehicle-level details. However, some types of data, data fields, tabs, windows, and/or other elements may be included in the UI view 110, or omitted from the UI view 110, based on the operation type 114 and/or the user type 118 associated with the operation. For instance, if the mode 122 is a special mode such that policy-level details and vehicle-level details are to be presented in the UI view 110, renewal term details may be presented in the UI view 110 if the operation type 114 is a policy renewal operation, but may be omitted from the UI view 110 if the operation type 114 is a different type of operation. Similarly, if the mode 122 is a special mode such that policy-level details and vehicle-level details are to be presented in the UI view 110, proration details may be presented in the UI view 110 if the user type 118 is a type of user that has permission to see those proration details, but may be omitted from the UI view 110 if the user type 118 is a different type of user.

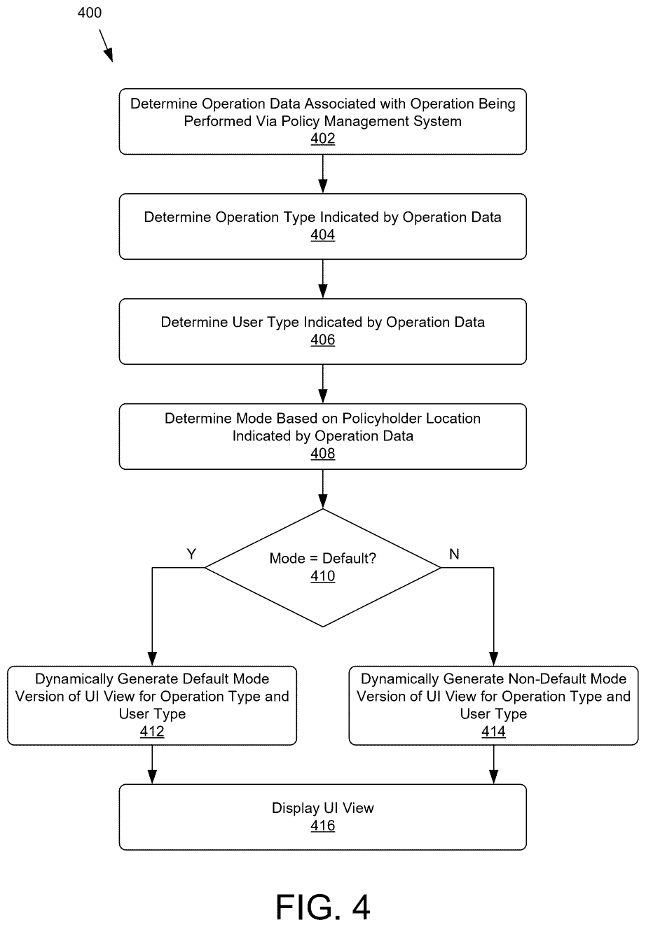

Accordingly, in some examples the mode 122 may identify overall types or categories of information that should, or should not, be displayed in a corresponding UI view 110. However, individual data elements, such as individual elements associated with the mode 122 and/or additional elements that are not associated with modes 122, may be associated with flags or conditions that correspond to one or more operation types 114 and/or one or more user types 118. The UI view generator 120 may use the operation type 114 and/or the location identifier 116 to determine whether to present such individual data elements within a UI view 110 associated with the operation. An example of using the UI view generator 120 using a mode 122 based on a location identifier 116, and using an operation type 114 and user type 118, to dynamically generate a UI view 110 associated with an operation is discussed further below with respect to FIG. 4.

In some examples, the policy management system 102 may natively be configured to present static UI views associated with corresponding operations based on corresponding separate code sets. For example, the policy management system 102 may natively be configured to present each distinct UI view 110 based on a different corresponding code set, such that if there are seven different UI views 110 that could display quote details in association with seven corresponding operation types, the policy management system 102 would natively use a different code set to display each of the seven different UI views 110. However, source code of the policy management system 102 may be refactored or otherwise modified such that the policy management system 102 uses the UI view generator 120 to dynamically generate and display UI views 110 based on values of one or more parameters instead of, or in addition to, presenting different predefined static UI views based on respective different code sets.

For instance, the policy management system 102 may be modified to use one code set associated with the UI view generator 120 in association with any of multiple types of operations, instead of using multiple distinct code sets that are respectively associated with different operations and/or different combinations of operation types, policyholder locations, and/or user types. In some examples, source code of the policy management system 102 may be refactored such that the UI view generator 120 executes as a part of the policy management system 102 to dynamically generate UI views 110 in association with corresponding operations performed via the policy management system 102. In other examples, the UI view generator 120 may execute as a distinct component that is separate from the policy management system 102 but may be called or accessed by the policy management system 102, or may execute as a plug-in or add-on to the policy management system 102. Accordingly, source code of the policy management system 102 may be refactored, or the policy management system 102 may be otherwise reconfigured, to cause the policy management system 102 to call or use the UI view generator 120 to dynamically generate UI views 110 in association with corresponding operations instead of using multiple native code sets that are associated with multiple static UI views.

Because the policy management system 102 may be modified to use one code set associated with the UI view generator 120, instead of using multiple distinct code sets that are respectively associated with different static and predetermined UI views, the policy management system 102 may use fewer computing resources in association with the UI view generator 120 than in association with multiple distinct code sets. As an example, the policy management system 102 may use less memory to store code for the UI view generator 120 that is configured to dynamically generate UI views 110, relative to amounts of memory that would be used to store multiple distinct code sets that are respectively associated with different static and predetermined UI views.

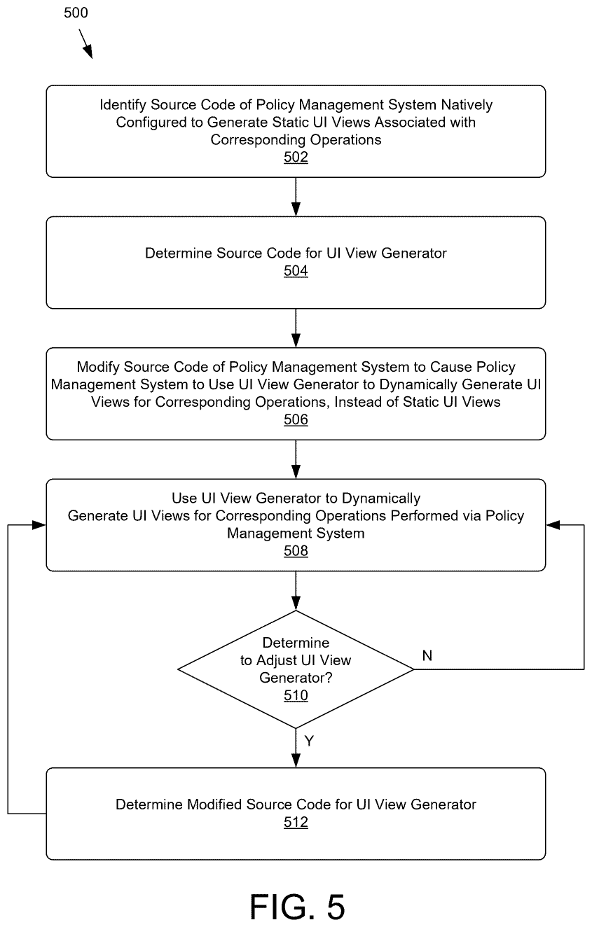

Similarly, because the policy management system 102 may be modified to use one code set associated with the UI view generator 120, instead of using multiple distinct code sets that are respectively associated with different static and predetermined UI views, usage of time and computing resources associated with testing and/or maintenance of the policy management system 102 may be reduced. For example, an information technology (IT) system 124 may be used to test the policy management system 102, to update the policy management system 102, and/or to diagnose and fix problems with the policy management system 102, as discussed further below with respect to FIG. 5. The IT system 124 may use fewer computing cycles, memory, and/or other computing resources to test one code set associated with the UI view generator 120, than to test multiple distinct code sets that are respectively associated with different static and predetermined UI views. Similarly, the IT system 124 may use fewer computing cycles, memory, and/or other computing resources to identify and fix bugs in the single code set associated with the UI view generator 120, relative to identifying and fixing bugs in multiple distinct code sets that are respectively associated with different static and predetermined UI views.

In addition, the IT system 124 may edit the code set associated with the UI view generator 120, for instance to add new features or adjust how UI views 110 are dynamically created, more quickly and/or with use of fewer computing resources relative to editing and/or creating multiple code sets for static UI views. As a non-limiting example, the UI view generator 120 may dynamically generate a UI view 110 for an operation based in part on the mode 122 associated with the operation, as discussed above. In this example, the code set for the UI view generator 120 may initially be configured with two modes 122, respectively corresponding to two different sets of states that have different requirements for how information is to be displayed in the UI 106. The policy management system 102 may become configured to manage policies associated with a third set of states that has a third set of requirements for how information is to be displayed in the UI 106. In this situation, the IT system 124 may be used to edit the code set for the UI view generator 120, in order to define and implement a third mode associated with the third set of states that causes policy information for policyholders in those states to be displayed according to the third set of requirements. The new third mode may be implemented by editing the single code set for the UI view generator 120, instead of creating multiple new code sets for multiple static UI views associated with different operations that display corresponding information according the third set of requirements. As a result, the new third mode may be implemented and/or tested more quickly, and/or with the use of fewer computing cycles, memory, and/or other computing resources, relative to creating and testing multiple new code sets for multiple static UI views that display corresponding information according the third set of requirements.

Overall, the UI view generator 120 may dynamically generate UI views 110 for operations of the policy management system 102 that are associated with any combination of an operation type 114, a user type 118, and a mode 122 corresponding to a location identifier 116. Examples of UI views 110 that may be generated by the UI view generator 120 are discussed further below with respect to FIG. 2 and FIG. 3.

FIG. 2 shows an example of a first UI view 200 that may be displayed in the UI 106 of the policy management system 102 for an operation based on a first mode 122. A value of the operation type 114 associated with the operation may indicate that the operation is a policy change operation. The first UI view 200 may accordingly present policy information associated with the policy change operation, such as quote information and/or other information determined by the policy management system 102 based on potential or completed changes to an existing policy.

The first UI view 200 may be dynamically generated by the UI view generator 120 in association with a first mode 122. As shown in FIG. 2, the policyholder associated with the policy change operation may be located in the state of Ohio. A value of the location identifier 116 associated with the operation may accordingly indicate that the corresponding policyholder is located in Ohio. Ohio may be a state that is associated with the first mode 122, such that the UI view generator 120 may use the location identifier 116 to determine that the first mode 122 applies to the policy change operation.

The first mode 122 may indicate that summarized details 202, associated with both the overall policy and one or more vehicles covered by the policy, are to be displayed as quote details within the first UI view 200. Accordingly, the UI view generator 120 may dynamically generate the first UI view 200 such that the first UI view 200 presents summarized details 202, derived from policy data 104, user input, and/or other information, as quote details associated with the policy change operation.

The UI view generator 120 may also cause the first UI view 200 to display other elements in addition to the summarized details 202, such as vehicle-level rating information 204, policy information 206, selectable tabs 208, and/or other information or user interface elements as shown in FIG. 2. In some examples, the UI view generator 120 may determine to display or hide individual elements, such as individual data fields, tabs, windows, boxes, or other elements that are part of the summarized details 202 and/or are separate from the summarized details 202, within the first UI view 200 based on the mode 122, operation type 114, and/or user type 118 associated with the operation.

As a non-limiting example, the UI view generator 120 may determine to show certain policy information 206 fields, such as the “current 6-month premium,” the “new 6-month premium,” and the “difference in premium” fields, because the operation being performed is a policy change operation that may result in a difference between a current premium and a new premium. However, if the operation being performed was a new policy operation or another type of operation that did not or would not result in a premium change, the UI view generator 120 may be configured to hide or omit elements such as the “new 6-month premium,” and the “difference in premium” fields from a corresponding generated UI view 110, even if the same or similar summarized details 202 and/or other information shown in FIG. 2 would still be displayed in association with the other operation type.

As discussed above, summarized details 202 associated with a policy change operation may be displayed within the first UI view 200 generated by the UI view generator 120 according to the first mode 122. However, as discussed further below with respect to FIG. 3, the UI view generator 120 may determine that different details associated with a policy change operation are to be displayed within a corresponding UI view 110 if a corresponding policyholder is associated with another mode 122 that is different from the first mode 122.

FIG. 3 shows an example of a second UI view 300 that may be displayed in the UI 106 of the policy management system 102 for an operation based on a second mode 122. A value of the operation type 114 associated with the operation may indicate that the operation is a policy change operation, similar to the operation associated with the first UI view 200 shown in FIG. 2. The second UI view 300 may accordingly present policy information associated with the policy change operation, such as quote information and/or other information determined by the policy management system 102 based on potential or completed changes to an existing policy.

The second UI view 300 may be dynamically generated by the UI view generator 120 in association with a second mode 122. The second mode 122 may be different than the first mode 122 discussed above with respect to FIG. 2. For example, the first mode 122 and the second mode 122 may be associated with different sets of states or other policyholder locations.

The policyholder associated with the policy change operation associated with the example of FIG. 3 may be located in the state of Nevada. Accordingly, a value of the location identifier 116 associated with the operation may indicate that the corresponding policyholder is located in Nevada. Nevada may be a state that is associated with the second mode 122, such that the UI view generator 120 may use the location identifier 116 to determine that the second mode 122 applies to the policy change operation.

The second mode 122 may indicate that policy-level details 302 and vehicle-level details 304 are to be displayed as quote details within the second UI view 300, instead of the summarized details 202 shown in FIG. 2. The policy-level details 302 may display types of information that are applicable to the overall policy, while the vehicle-level details 304 may be specific to each vehicle covered by the policy. If the policy covers multiple vehicles, different vehicle-level details 304 may be displayed for each of the vehicles. Accordingly, the UI view generator 120 may dynamically generate the second UI view 300 such that the second UI view 300 presents policy-level details 302 and vehicle-level details 304, derived from policy data 104, user input, and/or other information, as quote details associated with the policy change operation.

As shown in FIG. 3, the UI view generator 120 may also cause the second UI view 300 to display other elements in addition to the policy-level details 302 and the vehicle-level details 304, such as vehicle-level rating information 204, policy information 206, selectable tabs 208, and/or other information or user interface elements as discussed above with respect to FIG. 2. In some examples, the UI view generator 120 may determine to display or hide individual elements, such as individual data fields, tabs, windows, boxes, or other elements that are part of the policy-level details 302 and the vehicle-level details 304 and/or are separate from the policy-level details 302 and the vehicle-level details 304, within the second UI view 300 based on the mode 122, operation type 114, and/or user type 118 associated with the operation.

Overall, as discussed with respect to FIG. 2 and FIG. 3, the UI view generator 120 may determine information types, detail levels, information layouts, and/or other presentation attributes associated with a dynamically-generated UI view 110 based on a mode 122 determined based on the corresponding location identifier 116, based on the corresponding operation type 114, and/or based on the corresponding user type 118. A process for dynamically generating a UI view 110 for an operation based on such factors is discussed further below with respect to FIG. 4.

FIG. 4 shows a flowchart illustrating an example method 400 for dynamically generating a UI view for a corresponding operation performed via the policy management system 102. The method 400 shown in FIG. 4 may be performed by a computing system that executes the UI view generator 120, the policy management system 102, and/or other elements described herein. An example system architecture for such a computing system is described below with respect to FIG. 6.

At block 402, the computing system may determine operation data 112 associated with an operation being performed via the policy management system 102. As discussed above, users may use the policy management system 102 to perform various operations in association with policies, for instance based on user input provided by the users, based on policy data 104 maintained and/or accessible by the policy management system 102, and/or based on other data. The operation data 112 associated with the operation may be derived from such user input, policy data 104, and/or other data, and may indicate parameters such as an operation type 114 of the operation, a location identifier 116 indicating a location of a policyholder associated with the operation, and/or a user type 118 associated with the operation.

At block 404, the computing system may determine the operation type 114 indicated by the operation data 112. The operation type 114 may indicate which type of operation is being performed via the policy management system 102. As a non-limiting example, the policy management system 102 may allow users to perform submission operations associated with new policies, issuance operations associated with new policies, cancellation operations associated with existing policies, reinstatement operations associated with lapsed or canceled policies, renewal operations associated with renewals of existing policies for new terms, rewrite operations associated with replacements of policies, new account rewrite operations associated with replacements of policies in association with new accounts, and/or other types of operations. Accordingly, a value of the operation type 114 parameter in the operation data 112 determined at block 402 may indicate which particular type of operation is being performed via the policy management system 102.

At block 406, the computing system may determine the user type 118 indicated by the operation data 112. Multiple types of users may the policy management system 102, such as insurance agents, claims adjustors, insured parties, underwriters, developers of the policy management system 102, testers of the policy management system 102, IT support personnel, and/or other types of users, and the user type 118 may indicate which type of user is performing the operation via the policy management system 102.

At block 408, the computing system may determine the mode 122 associated with the operation, based on the location identifier 116 indicated by the operation data 112. The location identifier 116 may indicate a location of a policyholder associated with the operation, such as a policyholder associated with an existing policy being managed via the operation or a policyholder who is or will be associated with a new policy being created via the operation. The computing system may be configured to associate different sets of states or different sets of other locations, with different modes 122. For example, code of the UI view generator 120 may indicate which sets of states are associated with each mode 122. Accordingly, the computing system may determine which of the modes 122 corresponds to the policyholder location indicated by the location identifier 116. The modes 122 may each be defined to indicate corresponding presentation formats, such as particular types of information and/or particular layouts or detail levels, to be used to present information according to the modes 122.

At block 410, the computing system may determine if the mode 122 identified at block 408 is a default mode 122. If the mode 122 is the default mode 122 (Block 410—Yes), at block 412 the computing system may use the default mode 122 to dynamically generate a UI view 110 that corresponds to the operation type 114 and the location identifier 116. As an example, if the default mode 122 indicates that quote details associated with the operation are to displayed as or include summarized details 202 instead of policy-level details 302 and vehicle-level details 304, the computing system may generate the UI view 110 to include summarized details 202 derived from user input, policy data 104, and/or data available to the policy management system 102 and/or the UI view generator 120.

At block 412, the computing system may also generate the UI view 110 by using the operation type 114 and/or the user type 118 associated with the operation to determine other information to display, or omit from display, in the generated UI view 110. For example, although the default mode 122 may indicate that summarized details 202 are to be displayed in the UI view 110, elements of the UI view 110 that are part of the summarized details 202, or are separate from the summarized details 202, may be displayed or hidden on an individual basis according to the operation type 114 and/or the user type 118 associated with the operation.

If the mode 122 is not the default mode 122 (Block 410—No), at block 414 the computing system may use a different mode 122 corresponding to the location identifier 116 to dynamically generate a UI view 110 that corresponds to the operation type 114 and the location identifier 116. As an example, if the mode 122 indicates that quote details associated with the operation are to displayed as or include policy-level details 302 and vehicle-level details 304 instead of summarized details 202, the computing system may generate the UI view 110 to include policy-level details 302 and vehicle-level details 304 derived from user input, policy data 104, and/or data available to the policy management system 102 and/or the UI view generator 120.

At block 414, the computing system may also generate the UI view 110 by using the operation type 114 and/or the user type 118 associated with the operation to determine other information to display, or omit from display, in the generated UI view 110. For example, although the default mode 122 may indicate that policy-level details 302 and vehicle-level details 304 are to be displayed in the UI view 110, elements of the UI view 110 that are part of the policy-level details 302 and vehicle-level details 304, or are separate from the policy-level details 302 and vehicle-level details 304, may be displayed or hidden on an individual basis according to the operation type 114 and/or the user type 118 associated with the operation.

At block 416, the computing system may cause the UI view 110 dynamically generated at block 412 or block 414 to be displayed in the UI 106 of the policy management system 102. For example, the generated UI view 110 may be displayed in the UI 106, via a user device 108, in association with, or in response to, the operation performed via the policy management system 102.

Although method 400 indicates that block 410 determines whether the mode 122 associated with the operation is a default mode 122, in other examples block 410 may determine whether the mode 122 associated with the operation is a first mode 122 of a set of modes 122. If the mode 122 is the first mode 122, the computing system may generate the UI view 110 based on the first mode 122. If the mode 122 is not the first mode 122, the computing system may determine which of a set of other modes 122, such as a second mode 122, a third mode 122, a fourth mode 122, or any other mode 122, is associated with the operation, and may generate the UI view 110 based on that mode 122.

As shown in FIG. 4, the computing system may dynamically generate a UI view 110 associated with an operation based on the mode 122 that corresponds to the location identifier 116, based on the operation type 114, and based on the operation data 112. Accordingly, the computing system may dynamically generate a UI view 110 for numerous, or any, combinations of operation types 114, location identifiers 116, and/or user types 118, without relying on different static and predetermined UI views that correspond to different possible combinations of operation types 114, location identifiers 116, and/or user types 118. FIG. 5, discussed further below, shows a process for modifying a version of the policy management system 102 that natively uses multiple different pre-coded code sets that are associated with presenting different UI views corresponding to different operation types, policyholder locations, and/or other variables to instead use a single code set associated with the UI view generator 120 to dynamically generate a UI view 110 for any combinations of the operation type 114, the location identifier 116, and/or the user type 118.

FIG. 5 shows a flowchart illustrating an example method 500 for modifying the policy management system 102 to use the UI view generator 120 to dynamically generate UI views 110 associated with operations performed via the policy management system 102. The method 500 shown in FIG. 5 may be performed by a computing system that executes the IT system 124, the policy management system 102, the UI view generator 120, and/or other elements described herein. An example system architecture for such a computing system is described below with respect to FIG. 6.

At block 502, the computing system may identify source code of a version of the policy management system 102 that is natively configured to use different code sets to generate different static UI views 110 in association with operations. As an example, if the policy management system 102 allows users to perform seven different types of operations, the native source code of the policy management system 102 may include seven distinct and different code sets that can be used to display seven different UI views that respectively correspond to the seven different types of operations, even if the seven different UI views display most of the same types of information. If the UI views present quote information associated with operations, and many of the same types of quote information are to be displayed in association with each type of operation, the seven different code sets may each include a significant amount of repeated or redundant code associated with the display of the same types of quote information. As another example, if the policy management system 102 allows users to perform seven different types of operations, but different types of information may be displayed depending on whether the corresponding policyholder is located in a first set of states or in a second set of states, the native source code of the policy management system 102 may include fourteen distinct and different code sets that can be used to display fourteen different UI views that respectively correspond to different combinations of the seven different types of operations and the two different sets of states.

At block 504, the computing system may determine source code for the UI view generator 120. As described herein, the UI view generator 120 dynamically generate a UI view 110 for any operation associated with any combination of a mode 122 determined based on a location identifier 116 indicating a policyholder location, an operation type 114, and a user type 118 associated with an operation. The UI view generator 120 may be executed via one code set that is configured to identify the mode 122, the operation type 114, and/or the user type 118 associated with the operation, and to dynamically generate a corresponding UI view 110 based on those identified factors.

At block 506, the computing system may modify the native source code of the policy management system 102, to cause the policy management system 102 to use the UI view generator 120 to dynamically generate UI views 110 for corresponding operations instead of using static UI views that the policy management system 102 was previously and natively configured to use. For example, at block 506 the source code of the policy management system 102 may be modified to use the single code set associated with the UI view generator 120, instead of multiple distinct code sets associated with static UI views that the policy management system 102 was previously configured to use, when displaying information associated with operations in the UI 106.

In some examples, the source code of the policy management system 102 may be refactored or otherwise modified to directly use the single code set of the UI view generator 120 instead of numerous native code sets associated with static UI views. In other examples, the source code of the policy management system 102 may be modified to cause the policy management system 102 to call a version of the UI view generator 120 that executes as a separate service or application. In still other examples, the policy management system 102 may be re-coded, or settings of the policy management system 102 may be changed or reconfigured without modification to its source code, to cause the policy management system 102 to call or use the policy management system 102 as a separate service or application, as a plug-in or other add-on, or via any other technique. The computing system that executes the policy management system 102 and/or the UI view generator 120 may consume fewer computing resources to store and/or use the single code set of the UI view generator 120, relative to storing and using numerous code sets associated with static UI views that the policy management system 102 was natively configured to use.

At block 508, the computing system may cause the policy management system 102 to use the UI view generator 120 to dynamically generate UI views 110 for corresponding operations. For example, the UI view generator 120 may use the method 400 shown in FIG. 4 to dynamically generate UI views 110 for operations based on modes 122 determined based on corresponding location identifiers 116, based on corresponding operation types 114, and/or based on corresponding user types 118.

At block 510, the computing system may determine whether the UI view generator 120 is to be adjusted. As an example, a user of the IT system 124 may have received an incident report indicating a problem with UI views 110 generated by the UI view generator 120. As another example, if the UI view generator 120 is configured to identify which of two modes 122 corresponding to two different sets of states is associated with an operation, but a new third mode 122 associated with a third set of states is to be implemented, the UI view generator 120 may need to be adjusted to cause the UI view generator 120 to use the third mode 122.

If the UI view generator 120 is not set to be adjusted (Block 510—No), the policy management system 102 may continue to use the UI view generator 120 to dynamically generate UI views 110 for corresponding operations at block 508. However, if the UI view generator 120 is set to be adjusted (Block 510—Yes), the computing system may determine modified source code for the UI view generator 120 at block 512. As an example, if a user of the IT system 124 discovered a bug or other issue with the UI view generator 120, the user may have edited the source code of the UI view generator 120 to resolve that issue. As another example, if a new mode 122 is being introduced, a user of the IT system 124 may have edited the source code of the UI view generator 120 to cause the UI view generator 120 to identify whether a location identifier 116 corresponds with the new mode 122, and if so to dynamically generate a corresponding UI view 110 based at least in part on the new mode 122.

After the modified source code for the UI view generator 120 is determined at block 512, the computing system may cause the policy management system 102 to use the modified version of the UI view generator 120 to dynamically generate UI views 110 for corresponding operations at block 508. In some examples in which the UI view generator 120 is executed via modified source code of the policy management system 102, the source code of the policy management system 102 may be further modified according to the modified source code for the UI view generator 120 is determined at block 512. In other examples in which the UI view generator 120 is a separate executable element, a plug-in, or other separate element, the policy management system 102 may be able to call or use the modified UI view generator 120 without further modification of the policy management system 102.

Overall, the UI view generator 120 may be executed and/or updated more efficiently than multiple code sets for different static UI views that the policy management system 102 may otherwise natively be configured to use. For example, the single code set for the UI view generator 120 may be stored, tested, and/or executed using fewer computing resources than it would take to store, test, and execute multiple native code sets for different static UI views. Similarly, the single code set for the UI view generator 120 may be edited to fix bugs or otherwise resolve issues, and/or to add new features, more quickly than editing multiple native code sets for different static UI views, and without the risk that edits to the multiple native code sets may be inconsistent or introduce errors to one or more of the native code sets.

FIG. 6 shows an example system architecture 600 for a computing system 602 that may execute one or more elements of the policy management system 102, the UI view generator 120, and/or other elements described herein. The computing system 602 may include one or more computers, servers, or other types of computing devices. Individual computing devices of the computing system 602 may have the system architecture 600 shown in FIG. 6, or a similar system architecture. In some examples, the user device 108, the IT system 124, and/or other elements described herein may also have the system architecture 600 shown in FIG. 6, or a similar system architecture.

In some examples, elements associated with the policy management system 102 and/or the UI view generator 120 may be distributed among, and/or be executed by, multiple computing systems or devices similar to the computing system 602 shown in FIG. 6. As an example, the UI view generator 120 may be executed by a different computing system than a computing system that executes other components of the policy management system 102 and/or that stores the policy data 104 used by the policy management system 102. The computing system 602 may, in some examples, include or be part of a cloud computing environment or other distributed system that hosts and/or executes one or more elements associated with the policy management system 102 and/or the UI view generator 120.

The computing system 602 may include memory 604. In various examples, the memory 604 may include system memory, which may be volatile (such as RAM) , non-volatile (such as ROM, flash memory, etc.) or some combination of the two. The memory 604 may further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which may be used to store desired information and which may be accessed by the computing system 602. Any such non-transitory computer-readable media may be part of the computing system 602.

The memory 604 may store data and/or computer-executable instructions, such as data and/or computer-executable instructions associated with software elements. For instance, the memory 604 may store data and/or computer-executable instructions associated with the policy management system 102, policy data 104 maintained and used by the policy management system 102, the UI view generator 120, and/or other elements described herein.

As an example, the memory 604 may store the policy data 104 maintained and used by the policy management system 102. As another example, the memory 604 may store data and/or computer-executable instructions associated with the policy management system 102 and/or the UI view generator 120. In some examples, the UI view generator 120 may be an element of the policy management system 102, and be executed via data and/or computer-executable instructions associated with the policy management system 102. In other examples, the UI view generator 120 may be a separate component, such as a plug-in or separate executable element, that executes via separate data and/or computer-executable instructions, but may be accessed or called by one or more elements of the policy management system 102.

The memory 604 may also store other modules and data 606 that may be utilized by the computing system 602 to perform or enable performing any action taken by the computing system 602. For example, the other modules and data 606 may include a platform, operating system, and/or applications, as well as data utilized by the platform, operating system, and/or applications.

The computing system 602 may also have processor(s) 608, communication interfaces 610, a display 612, output devices 614, input devices 616, and/or a drive unit 618 including a machine readable medium 620.

In various examples, the processor(s) 608 may be a central processing unit (CPU), a graphics processing unit (GPU), both a CPU and a GPU, or any other type of processing unit. Each of the one or more processor(s) 608 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 608 may also be responsible for executing computer applications stored in the memory 604, which may be associated with types of volatile (RAM) and/or nonvolatile (ROM) memory.

The communication interfaces 610 may include transceivers, modems, network interfaces, antennas, and/or other components that may transmit and/or receive data over networks or other connections. In some examples, the communication interfaces 610 may be used to exchange data between elements described herein.

The display 612 may be a liquid crystal display, or any other type of display commonly used in computing devices. In some examples, the UI 106 and UI views 110 generated by the UI view generator 120 may be displayed via the display 612. The output devices 614 may include any sort of output devices known in the art, such as the display 612, speakers, a vibrating mechanism, and/or a tactile feedback mechanism. Output devices 614 may also include ports for one or more peripheral devices, such as headphones, peripheral speakers, and/or a peripheral display.

The input devices 616 may include any sort of input devices known in the art. For example, input devices 616 may include a microphone, a keyboard/keypad, and/or a touch-sensitive display, such as a touch-sensitive display screen. A keyboard/keypad may be a push button numeric dialing pad, a multi-key keyboard, or one or more other types of keys or buttons, and may also include a joystick-like controller, designated navigation buttons, or any other type of input mechanism.

The machine readable medium 620 may store one or more sets of instructions, such as software or firmware, that embodies any one or more of the methodologies or functions described herein. The instructions may also reside, completely or at least partially, within the memory 604, processor(s) 608, and/or communication interface(s) 610 during execution thereof by the computing system 602. The memory 604 and the processor(s) 608 also may constitute machine readable media 620.

Although the subject matter has been described in language specific to structural features and/or methodological acts, it is to be understood that the subject matter is not necessarily limited to the specific features or acts described above. Rather, the specific features and acts described above are disclosed as example embodiments.

1. A computer-implemented method, comprising:
determining, by a computing system comprising a processor, operation data associated with an operation performed via a policy management system, wherein the operation data indicates:
an operation type associated with the operation, and
a location identifier indicating a policyholder location associated with the operation;
selecting, by the computing system, and based on mapping data, a particular mode that corresponds with the location identifier from among different predefined modes that respectively correspond to:
different sets of locations, and
different presentation formats;
dynamically generating, by the computing system, a user interface view that presents information associated with the operation using a particular presentation format that corresponds with the particular mode, wherein:
individual elements of the information are displayed or hidden in the user interface view according to the operation type; and
causing, by the computing system, the user interface view to be presented via a user interface of the policy management system.

2. The computer-implemented method of claim 1, wherein the different predefined modes comprise:
a default mode associated with a first set of locations, and
a specialized mode associated with a second set of locations different from the first set of locations.

3. The computer-implemented method of claim 2, wherein:
the user interface view presents quote information associated with a policy,
the default mode indicates that the quote information is to be displayed in the user interface view as summarized details, and
the specialized mode indicates that the quote information is to be displayed in the user interface view as policy-level details and vehicle-level details.

4. (canceled)

5. The computer-implemented method of claim 1, wherein:
the operation data indicates a user type of a user of the policy management system, and
dynamically generating the user interface view comprises determining to display or hide an element of the user interface view based on the user type.

6. The computer-implemented method of claim 1, wherein the operation type indicates that the operation is one of:
a policy submission operation,
a policy issuance operation,
a policy cancellation operation,
a policy reinstatement operation,
a policy renewal operations,
a policy rewrite operation, or
a policy new account rewrite operation.

7. The computer-implemented method of claim 1, wherein:
the policy management system is natively coded to use a plurality of distinct code sets, respectively associated with corresponding operation types, to generate predetermined user interface views in association with instances of the corresponding operation types, and
the computer-implemented method further comprises modifying, by the computing system, the policy management system to dynamically generate the user interface view based on the operation type and the particular mode, determined based on the operation data, instead of using the plurality of distinct code sets.

8. A computing system, comprising:
one or more processors, and
memory storing computer-executable instructions that, when executed by the one or more processors, cause the one or more processors to:
execute a policy management system configured to perform operations to manage policies based on corresponding policy data;
determine operation data associated with an operation performed via the policy management system, wherein the operation data indicates:
an operation type associated with the operation, and
a location identifier indicating a policyholder location associated with the operation;
select, based on mapping data, a particular mode that corresponds with the location identifier from among different predefined modes that respectively correspond to:
different sets of locations, and
different presentation formats;
dynamically generate a user interface view that presents information associated with the operation using a particular presentation format that corresponds with the particular mode, wherein:
individual elements of the information are displayed or hidden in the user interface view according to the operation type; and
cause the user interface view to be presented via a user interface of the policy management system.

9. The computing system of claim 8, wherein the different predefined modes comprise:
a default mode associated with a first set of locations, and
a specialized mode associated with a second set of locations different from the first set of locations.

10. The computing system of claim 9, wherein:
the user interface view presents quote information associated with a policy,
the default mode indicates that the quote information is to be displayed in the user interface view as summarized details, and
the specialized mode indicates that the quote information is to be displayed in the user interface view as policy-level details and vehicle-level details.

11. (canceled)

12. The computing system of claim 8, wherein:
the operation data indicates a user type of a user of the policy management system, and
dynamically generating the user interface view comprises determining to display or hide an element of the user interface view based on the user type.

13. The computing system of claim 8, wherein the operation type indicates that the operation is one of:
a policy submission operation,
a policy issuance operation,
a policy cancellation operation,
a policy reinstatement operation,
a policy renewal operations,
a policy rewrite operation, or
a policy new account rewrite operation.

14. The computing system of claim 8, wherein:
the policy management system is natively coded to use a plurality of distinct code sets, respectively associated with corresponding operation types, to generate predetermined user interface views in association with instances of the corresponding operation types, and
the computer-executable instructions further cause the one or more processors to modify the policy management system to dynamically generate the user interface view based on the operation type and the particular mode, determined based on the operation data, instead of using the plurality of distinct code sets.

15. One or more non-transitory computer-readable media storing computer-executable instructions associated with a policy management system that, when executed by one or more processors of a computing system, cause the policy management system to:
determine operation data associated with an operation performed via the policy management system, wherein the operation data indicates:
an operation type associated with the operation, and
a location identifier indicating a policyholder location associated with the operation;
select, based on mapping data, a particular mode that corresponds with the location identifier from among different predefined modes that respectively correspond to:
different sets of locations, and
different presentation formats;
dynamically generate a user interface view that presents information associated with the operation using a particular presentation format that corresponds with the particular mode, wherein:
individual elements of the information are displayed or hidden in the user interface view according to the operation type; and
cause the user interface view to be presented via a user interface of the policy management system.

16. The one or more non-transitory computer-readable media of claim 15, wherein the different predefined modes comprise:
a default mode associated with a first set of locations, and
a specialized mode associated with a second set of locations different from the first set of locations.

17. The one or more non-transitory computer-readable media of claim 16, wherein:
the user interface view presents quote information associated with a policy,
the default mode indicates that the quote information is to be displayed in the user interface view as summarized details, and
the specialized mode indicates that the quote information is to be displayed in the user interface view as policy-level details and vehicle-level details.

18. (canceled)

19. The one or more non-transitory computer-readable media of claim 15, wherein:
the operation data indicates a user type of a user of the policy management system, and
dynamically generating the user interface view comprises determining to display or hide an element of the user interface view based on the user type.

20. The one or more non-transitory computer-readable media of claim 15, wherein:
the computer-executable instructions are, at a first time, configured to cause the policy management system to use a plurality of distinct code sets, respectively associated with corresponding operation types, to generate predetermined user interface views in association with instances of the corresponding operation types, and
the computer-executable instructions are, at a second time, modified to cause the policy management system to dynamically generate the user interface view based on the operation type and the particular mode, determined based on the operation data, instead of using the plurality of distinct code sets.

21. The computer-implemented method of claim 1, wherein:
the individual elements comprise a first data element associated with a condition,
the first data element is displayed in the user interface view based on the operation type satisfying the condition, and
the first data element is hidden from the user interface view based on the operation type failing to satisfy the condition.

22. The computer-implemented method of claim 1, wherein the operation data is based at least in part on user input provided via the user interface of the policy management system and policy data maintained by the policy management system.

23. The computer-implemented method of claim 1, wherein:
the individual elements of the information that are displayed or hidden according to the operation type comprise renewal term details,
the renewal term details are displayed in the user interface view based on the operation type being determined to be a policy renewal operation, and
the renewal term details are hidden from the user interface view based on the operation type being determined to be another type of operation different from the policy renewal operation.
